(19) United States
(12) Patent Application Publication
(10) Pub. No.: US 2007/0245948 A1
(43) Pub. Date: Oct. 25, 2007

(54) Bookmark

(76) Inventor: Thomas L. Paulin, Alloway, NJ (US)

Correspondence Address: BRUCE E. WEIR, 12 SPARROW VALLEY COURT, MONTGOMERY VILLAGE, MD, 20886-1265, US

(21) Appl. No.: 11/788,330

(22) Filed: Apr. 19, 2007

Related U.S. Application Data
(60) Provisional application No. 60/793,204, filed on Apr. 20, 2006.

(51) Int. Cl. B42D 9/00

(52) U.S. Cl. 116/239

(57) ABSTRACT

A bookmark attaches to a book by encircling the book's pages with a loop within the book's covers. The encircling loop is created by bending a length of cord or other thin material into a U-shape, then joining two pairs of points on the legs of the “U” with two stops. A thin card attached to the closed end of the “U” serves as a marker. The upper stop is closest to the closed end of the “U” and is centered against the upper end of the book's binding. Each leg of the “U” is laid as tightly against the binding as possible along a fold between a different book cover or page and adjacent page. The lower stop is closest to the open end of the “U” and is tightened against the lower end of the binding to secure the loop around the pages. The loose ends of the “U” may then be folded upward and secured between book pages.

### CROSS-REFERENCE TO RELATED APPLICATION

This application claims priority from provisional patent application Ser. No. 60/793,204, filed Apr. 20, 2006 by the same inventor, now pending.

### BACKGROUND

Over the centuries readers have employed many different devices for marking pages of interest within books. A common practice is to insert some thin, flat object between pages. However, loose bookmarks are notorious for falling out at inopportune times and becoming lost.

Some books have one end of a cord or strap glued into the binding, allowing the reader to place the other end between pages. But most books are not so equipped and require some sort of marker that can be conveniently attached and detached. Markers that clip to the binding of a book are easy to install but often just as easy to dislodge. Clips may damage a book. Markers that wrap around the front or rear cover of a book can be more secure but may be unnecessarily bulky and elaborate and may interfere with shelving or stacking the book.

What is needed is a bookmark that is simple; secure; easy to install, use, and remove; and not damaging to a book.

### SUMMARY

An embodiment of the present invention provides a simple and secure bookmark by bending a length of thin retainer material at its approximate center to form a bent-end, a first end, and a second end. An upper stop near the bent-end joins two points on the length of retainer material on either side of the bent-end to form a first loop between the bent-end and the upper stop. A thin card or other place-holding member is attached to the first loop. The upper stop is placed against the upper end of a book's binding and the portions of retainer material between the upper stop and the first and second ends are each laid tightly against lines where different pages are attached to the book's binding, so that the first and second ends hang below the bottom end of the book's binding. A lower stop joins the retaining material near the first and second ends to form a second loop. The lower stop is tightened against the lower end of the binding so that the second loop tightly encircles the book's pages without protruding outside the book's covers. All of these features and advantages of the present invention, and more, are illustrated below in the drawings and detailed description that follow.

### BRIEF DESCRIPTION OF THE DRAWINGS

FIG. 1 shows a perspective view of an embodiment of a bookmark installed within a book.

FIG. 2 shows a plan view of an initial step in the construction of a retaining member.

FIG. 3 shows a plan view of a partially-constructed retaining member with an upper stop.

FIG. 4 shows a plan view of a partially-constructed retaining member girth-hitched to a place-holding member.

FIG. 5 shows a perspective view of a partially-installed bookmark being mounted within the front cover of a book.

FIG. 6 shows a perspective view of a partially-installed bookmark being mounted within the rear cover of a book.

FIG. 7 shows a perspective view of a partially-installed bookmark being secured to the pages of a book.

FIG. 8 shows a perspective view of the free ends of a bookmark being rotated upward and inserted between the pages of a book.

FIG. 9 shows perspective view of a book with a bookmark attached and ready for use.

### DETAILED DESCRIPTION

A compact, simple bookmark that can be easily secured to the pages of any book without employing clips or external straps may be fabricated from a retaining member and a place-holding member. FIG. 1 shows an embodiment of such a bookmark unobtrusively installed within a book.

FIG. 2 shows an initial step in the construction of a retaining member. A length of thin, narrow retainer material 1 comprising a cord, thin webbing, flat braid, narrow strip or any of a variety of similar known materials is folded approximately in half to form a first end 3, a second end 4, and a bent-end 2. The retainer material may be elastic or inelastic.

FIG. 3 shows a partially-constructed retaining member with an upper stop. The upper stop 5 may be positioned approximately three inches from the bent-end 2, forming a first loop 6 with the first end 3 and second end 4 below. The upper stop 5 may be a knot, cordlock, clamp, tri-glide, or other known device for forming a fixed, enlarged spot on a length of narrow material.

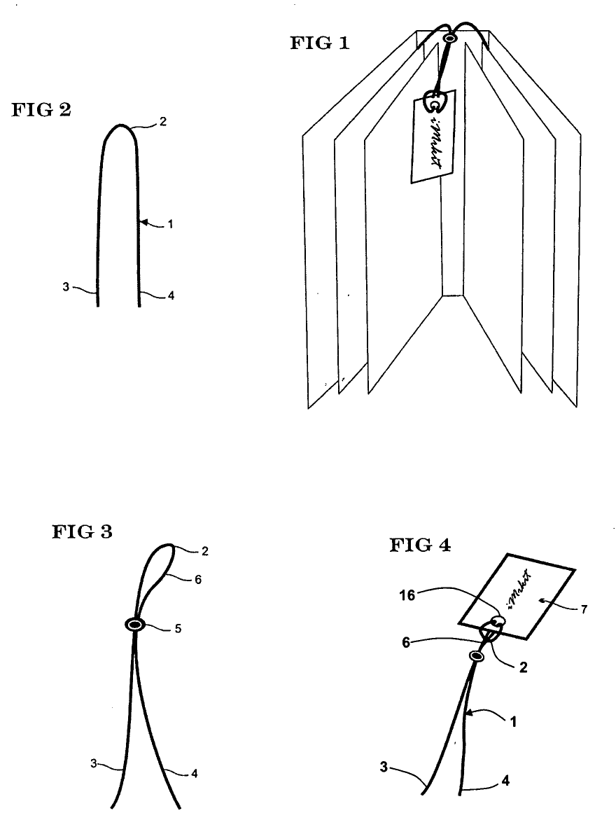

FIG. 4 shows a partially-constructed retaining member girth-hitched to a place-holding member. The place-holding member 7 is preferentially a thin piece of sheet material in any suitable size, shape, color, or composition. In this embodiment the bent-end 2 is passed though a hole 16 in the place-holding member 7, then the first and second ends 3, 4 are passed through the first loop 6 to form a girth hitch. Alternatively, the first loop 6 may be attached to the place-holding member by different knots, fasteners, adhesives, and many other well-known means. The procedures of FIG. 3 and FIG. 4 may be performed in reverse order to accommodate different place-holding member materials or other means for attachment.

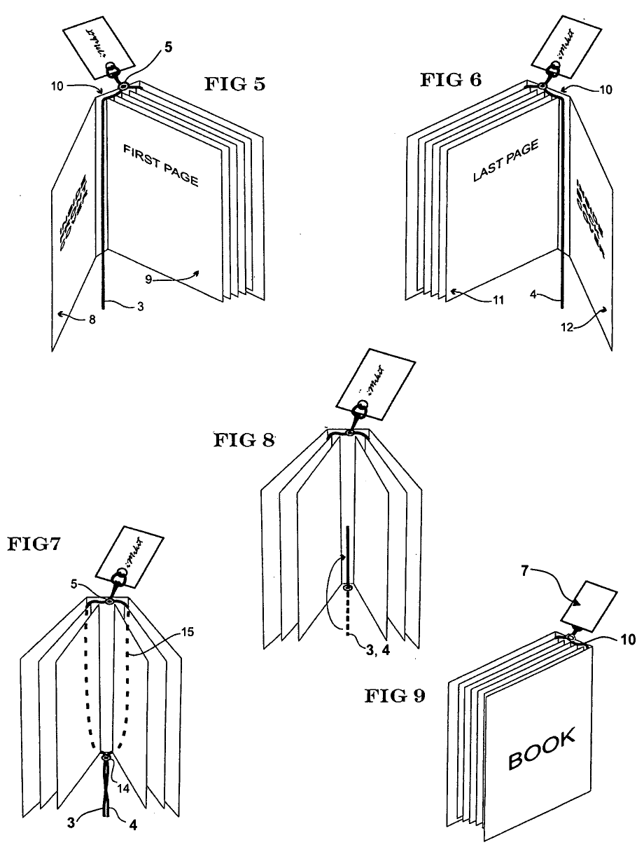

FIG. 5 shows a partially-installed bookmark being mounted within the front cover of a book. The upper stop 5 is approximately centered near the top of a book's binding 10 and the retainer material 1 between the upper stop 5 and the first end 3 is laid tight against the fold between the book's front inside cover 8 and first page 9 from the top of the book to the bottom with several inches of retainer material 1 hanging below the book.

FIG. 6 shows a partially-installed bookmark being mounted within the rear cover of a book. With the upper stop 5 still approximately centered near the top of a book's binding 10 the retainer material 1 between the upper stop 5 and the second end 4 is laid tight against the fold between the book's rear inside cover 12 and the last page 11 from the top of the book to the bottom with several inches of retainer material 1 hanging below the book. The steps of FIG. 5 and FIG. 6 may be performed in reverse order and may be performed between pages rather than between a page and a cover.

FIG. 7 shows a partially-installed bookmark being secured to the pages of a book. The first end 3 or second end 4 is pulled downward to center the upper stop 5, then both ends 3, 4 are pulled taut toward the bottom of the book and affixed together to create a second loop 15 that tightly encircles the pages of the book. The ends 3, 4 are affixed together with a lower stop 14 that may be a knot, cordlock, clamp, tri-glide, or other known device for forming a fixed spot on a length of material. In a simple embodiment the lower stop 14 may be a knot created simply by twisting the ends 3, 4 together until the lower stop 14 pulls tight against the bottom of the book. As shown in FIG. 8, the ends 3, 4 may then be rotated upward and inserted approximately in the center of the book to prevent them from dangling loose.

FIG. 9 shows a book with a bookmark attached and ready for use. The place-holding member 7 dangles freely near the top of the book's binding 10, ready for insertion between any adjacent pages. The rest of the bookmark, however, is contained entirely between the front and rear covers of the book so that no clip is needed and no external strap or cord protrudes from outer surface of either cover of the book. The parts of the bookmark are thin enough to avoid distorting the book while remaining securely attached as long as desired. The place-holding member is placed between pages tight near the binding, marking the desired page when the book is closed. The bookmark can be used to mark a page or can be positioned between open pages so as to mark the page if the book is accidentally closed. As more than one bookmark can be attached, many pages can be marked within the same book.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

I claim:

1. A bookmark, comprising:
a length of thin retainer material, the length of thin retainer material bent at its approximate center to form a bent-end, a first end, and a second end;
an upper stop proximate to the bent-end, the upper stop joining two points on the length of thin retainer material on either side of the bent-end to form a first loop in the length of thin retainer material between the bent-end and the upper stop;
a lower stop proximate to the first and second ends, the lower stop joining a point on the length of thin retainer material proximate to the first end to a point on the length of thin retainer material proximate to the second end to form a second loop in the length of thin retainer material between the lower stop and the upper stop; and
a place-holding member, the place-holding member attached to the first loop.

2. A bookmark as claimed in claim 1, wherein the upper and lower stops are selected from a group consisting of knots, cordlocks, clamps, and tri-glides.

3. A method for marking a place of interest within a book, comprising the steps of:
bending a length of thin retainer material near its center to form an open loop with a first end and a second end;
joining two points on the length of thin retainer material on either side of the center of the length of thin retainer material with an upper stop to create a first loop;
attaching a place-holding member to the first loop;
placing the upper stop against the upper end of a book's binding;
laying the portion of the length of thin retainer material between the upper stop and the first end tightly against a line where a primary page is attached to the book's binding so that the first end hangs below the bottom end of the book's binding;
laying the portion of the length of thin retainer material between the upper stop and the second end tightly against a line where a secondary page is attached to the book's binding so that the second end hangs below the bottom end of the book's binding;
pulling either the first end or the second end downward to center the upper stop with respect to the upper end of the book's binding;
joining two points on the portions of the length of thin retainer material hanging below the bottom end of the book's binding to create a lower stop and a second loop, the second loop encircling the book's pages within the book's front and rear covers;
adjusting the lower stop to tighten the second loop around the books pages; and
placing the place-holding member between two pages of the book.

4. A method for marking a place of interest within a book as claimed in claim 3, comprising the additional step of folding the first and second ends upward between two pages of the book after adjusting the lower stop to tighten the second loop around the books pages.

5. A method for marking a place of interest within a book, comprising the steps of:
bending a length of thin retainer material near its center to form an open loop with a first end and a second end;
joining two points on the length of thin retainer material on either side of the center of the length of thin retainer material with an upper stop to create a first loop;
attaching a place-holding member to the first loop;
placing the upper stop against the upper end of a book's binding;
laying the portion of the length of thin retainer material between the upper stop and the first end tightly against the fold between the book's front inside cover and first page so that the first end hangs below the bottom end of the book's binding;
laying the portion of the length of thin retainer material between the upper stop and the second end tightly against the fold between the book's rear inside cover and last page so that the second end hangs below the bottom end of the book's binding;
pulling either the first end or the second end downward to center the upper stop with respect to the upper end of the book's binding;
joining two points on the portions of the length of thin retainer material hanging below the bottom end of the book's binding to create a lower stop and a second loop, the second loop encircling the book's pages within the book's front and rear covers;
adjusting the lower stop to tighten the second loop around the books pages; and
placing the place-holding member between two pages of the book.

6. A method for marking a place of interest within a book as claimed in claim 5, comprising the additional step of folding the first and second ends upward between the pages of the book after adjusting the lower stop to tighten the second loop around the books pages.
